(19) United States
(12) Patent Application Publication
(10) Pub. No.: US 2008/0150436 A1
(43) Pub. Date: Jun. 26, 2008

(54) Chopper regulator circuit

(75) Inventor: Tomohiro Suzuki, Kashihara-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/976,699

(22) Filed: Oct. 26, 2007

(30) Foreign Application Priority Data
Dec. 21, 2006 (JP) 2006-344564

(51) Int. Cl. G09G 3/10; H02J 3/14

(52) U.S. Cl. 315/169.3; 307/38

(57) ABSTRACT

A chopper regulator circuit has: a power output portion for a first and a second load; a first output detection portion detecting the output to the first load; a second output detection portion detecting the output to the second load; a first and a second reference voltage generation portion; an output control portion controlling the amount of outputted electric power based on a result of comparison between two input voltages; and a switching control portion switching which of the first and second loads to supply electric power to and switching what voltages to handle as the input voltages. The input voltages are so switched that, when electric power is supplied to the first load, the detected voltage detected by the first output detection portion and the reference voltage generated by the first reference voltage generation portion are handled as the input voltages and, when electric power is supplied to the second load, the detected voltage detected by the second output detection portion and the reference voltage generated by the second reference voltage generation portion are handled as the input voltages. Thus, a chopper regulator circuit is realized that can easily supply two loads with adequate electric power with minimum disadvantages such as an increase in the total number of components needed.

This nonprovisional application claims priority under 35 U.S.C. § 119(a) on Patent Application No. 2006-344564 filed in Japan on Dec. 21, 2006, the entire contents of which are hereby incorporated by reference.

### BACKGROUND OF THE INVENTION

1. Field of the Invention

The present invention relates to a chopper regulator circuit that supplies electric power to a plurality of electrical loads.

2. Description of Related Art

Backlights for a liquid crystal display portion in mobile phones, mobile terminals, and the like generally use white LEDs (light-emitting diodes). These white LEDs are typically driven by step-up chopper regulators. On the other hand, nowadays, organic EL (electroluminescence) elements are increasingly used in such a display portion, contributing to the slimming-down of the display portion.

White LEDs mentioned above require a forward voltage as high as about 4 V, and their forward voltage tends to vary from one LED to another. For improved quality of display by liquid crystal, a backlight needs to produce even brightness. In mobile devices, most of which operate from batteries such as lithium-ion batteries, the brightness of individual LEDs is made even by passing equal currents through them, and this is achieved by connecting the LEDs in series and driving them with a step-up chopper regulator. Unlike these white LEDs, which are thus driven with a constant current, organic EL elements need to be driven with a constant voltage. Now, an example of a conventional step-up chopper regulator will be described with reference to FIG. 13.

The step-up chopper regulator shown in FIG. 13 is built as a chopper regulator IC 31, which includes an NPN transistor acting as an output switching transistor 14, a control circuit 12, a constant voltage circuit 13 supplying the control circuit 12 with a voltage, and other components. The control circuit 12 includes a drive circuit 15, a PWM comparator 16, an oscillation circuit 17, an error amplifier 18, a reference voltage source 20, and other components.

With this configuration, an LED group 6 acting as a load is driven in the following manner. First, switches 51 and 52 are turned on, and the deviation of the voltage VFB—appearing at an FB terminal as a result of the current Io through the LED group 6 flowing through a resistor 7—from the reference voltage VREF from the reference voltage source 20 is amplified by the error amplifier 18. Then, as shown in FIG. 14, the output (A) of the error amplifier 18 and the triangular oscillation wave (B) outputted from the oscillation circuit 17 are subjected to pulse width modulation by the PWM comparator 16, so that, by the resulting modulated signal, the output switching transistor 14 is controlled via the drive circuit 15.

When the output switching transistor 14 is on, a current flows through a coil 3 to the output switching transistor 14, storing energy in the coil 3. During this period, a current is supplied from an output capacitor 5 to the LED group 6. In contrast, when the output switching transistor 14 is off, the energy stored in the coil 3 raises the input voltage, and the raised voltage charges the output capacitor 5, and supplies the LED group 6 with a current.

In terms of the voltage VREF of the reference voltage source 20 and the resistance R7 of the resistor 7, the current Io through the LED group 6 is given by

Io=VREF/R7.

### For example, in a case where VREF is 0.1 V and the current Io through the LED group 6 needs to be 20 mA, the resistance R7 is calculated as 0.1 V/20 mA=5Ω.

Variations in the brightness of the LEDs are attributable to variations in the voltage VREF of the reference voltage source 20. Due to the chip fabrication process and other factors, the higher the voltage VREF, the smaller the variations. Inconveniently, however, the higher the voltage VREF, the higher the power loss in the resistor 7. For this reason, in battery-operated devices such as mobile devices, VREF is set low with a view to minimizing the shortening of the battery life. The power loss in the resistor 7 is given by

(Power Loss in Resistor 7)=VREF×Io(W).

On the other hand, when an organic EL element 11 is driven, the switches 51 and 52 are turned off, and instead a switch 53 is turned on. Now, a voltage divided from the output voltage by resistors 8 and 9 appears at the FB terminal, and the deviation of this voltage from the reference voltage from the reference voltage source 20 is amplified by the error amplifier 18.

Then, as shown in FIG. 14, the output (A) of the error amplifier 18 and the triangular oscillation wave (B) outputted from the oscillation circuit 17 are subjected to pulse width modulation by the PWM comparator 16, so that, by the resulting modulated signal, the output switching transistor 14 is controlled via the drive circuit 15, and thereby the output voltage is kept constant. The organic EL element 11 needs to be driven with a highly accurate voltage of 15 to 16 V. In this connection, conventional technologies are disclosed in, among others, JP-A-2005-295630 and JP-A-2006-211747.

With a conventional chopper regulator like the one described above, the electric power supplied to one load, namely the LED group, is approximately equal to the electric power supplied to the other load, namely the organic EL element. If, therefore, the two loads differ in the amount of electric power they need for proper light emission, it may be difficult to make each one of them emit light properly. Or, the organic EL element may suffer from large variations in its drive voltage.

One way to avoid such inconveniences is to provide a separate chopper regulator circuit for each of two loads, so that each load is supplied with the optimal amount of electric power. Inconveniently, however, providing components—such as a power source and a drive circuit, dedicated to each load leads to an increase in the total number of components needed, hampering the miniaturization and cost reduction of devices incorporating the chopper regulator.

### SUMMARY OF THE INVENTION

In view of the conventionally encountered inconveniences mentioned above, it is an object of the present invention to provide a chopper regulator circuit that can easily supply two loads with adequate electric power with minimum disadvantages such as an increase in the total number of components needed.

To achieve the above object, according to one aspect of the present invention, a chopper regulator circuit that is connected to a first and a second load to supply them with electric power is provided with: a power output portion that outputs electric power to the first and second loads; a first output detection portion that detects as a detected voltage the voltage or current outputted to the first load; a second output detection portion that detects as a detected voltage the voltage or current outputted to the second load; a first and a second reference voltage generation portion that each generates a predetermined reference voltage; an output control portion that compares two input voltages to control, based on the result of the comparison, the amount of electric power outputted from the power output portion; and a switching control portion that controls load switching for switching which of the first and second loads to supply electric power to and input switching for switching what voltages to handle as the input voltages. Here, the switch control portion, when performing the load switching so as to supply electric power to the first load, performs the input switching such that the detected voltage detected by the first output detection portion and the reference voltage generated by the first reference voltage generation portion are handled as the input voltages and, when performing the load switching so as to supply electric power to the second load, performs the input switching such that the detected voltage detected by the second output detection portion and the reference voltage generated by the second reference voltage generation portion are handled as the input voltages.

With this configuration, the reference voltage generation portion used when electric power is supplied to the first load and the reference voltage generation portion used when electric power is supplied to the second load are separately provided, and whichever of them is proper (whichever corresponds to the load to which to supply electric power) is chosen by the switching control portion. Thus, it is possible to supply either load with adequate electric power.

The switching of which of the loads to supply electric power to is achieved by the switching control portion switching between the reference voltage generation portions. Thus, in the chopper regulator circuit, it is possible to share components such as a drive circuit and a power source for the supplying of electric power to either load, and thereby to minimize disadvantages such as an increase in the total number of components needed.

In the above configuration, the first output detection portion may detect as the detected voltage the current outputted to the first load. In the above configuration, the second output detection portion may detect as the detected voltage the voltage outputted to the second load.

In the above configuration, the first output detection portion may detect as the detected voltage the current outputted to the first load; the second output detection portion may detect as the detected voltage the voltage outputted to the second load; and the reference voltage generated by the first reference voltage generation portion may be set lower than the reference voltage generated by the second reference voltage generation portion.

In the above configuration, the switching control may, prior to performing the load switching, perform the input switching. With this configuration, the load switching is prevented from being performed before the input switching is performed. Thus, it is possible to minimize the possibility of the load switching being performed before electric power is ready to be supplied to whichever of the loads is to receive electric power after the load switching.

In the above configuration, the first and second reference voltage generating portions may share a predetermined voltage source, and at least one of the first and second reference voltage generating portions may generate the reference voltage by dividing the voltage generated by the voltage source.

With this configuration, the two voltage generation portions can generate different voltages while sharing a single voltage source. This, compared with providing a separate voltage source for each voltage generation portion, makes it easier to minimize the number of extra components needed.

In the above configuration, synchronous rectification may be adopted. This configuration, compared with one adopting other rectification such as diode rectification, helps reduce power loss.

In the above configuration, the switching control portion may control the load switching and the input switching based on a signal fed from outside. With this configuration, the load switching and the input switching can be performed to suit actual needs in response to an appropriate signal fed from outside.

In the above configuration, the switching control portion may perform the load switching after first confirming that the output voltage to whichever of the first and second loads to which the output voltage has thus far been fed is equal to or lower than a predetermined level.

With this configuration, the load switching is performed after the output voltage to whichever of the loads to which it has thus far been fed becomes equal to or lower than a predetermined level. Thus, it is possible to easily prevent electric power from being supplied to both loads simultaneously.

In the above configuration, a grounding switch may be additionally provided by which the output path by way of which electric power is outputted to the first or second load is switched between a state connected to a grounded node and a state disconnected from the grounded node.

With this configuration, for example, when the load switching is performed, the output path by way of which electric power is outputted to the first or second load can be grounded to promote discharging and thereby make the output voltage fall quickly.

In the above configuration, supply stopping means may be additionally provided for stopping, based on the signal fed from outside, the supply of electric power such that neither of the first and second loads receives it.

With this configuration, in response to a signal fed from outside, the supply of electric power can be stopped such that neither of the first and second loads receives it.

In the above configuration, the supply stopping means may, when stopping the supply of electric power such that neither of the first and second loads receives it, stop the supply of the driving electric power to the output control portion.

With this configuration, it is possible to minimize the wasting of electric power resulting from the output control portion receiving driving electric power when neither of the first and second loads is supplied with electric power.

In the above configuration, an abnormal output detection portion may be additionally provided that checks whether or not the voltage or current outputted to the first or second load is equal to or higher than a predetermined level so that, based on the result of the checking, the chopper regulator circuit stops the supply of electric power.

With this configuration, in case excessive electric power is outputted to either of the loads for some cause, the condition is detected and the supply of electric power is stopped. Thus, it is possible to minimize damage to and other adverse effects on the device incorporating the chopper regulator circuit.

In the above configuration, an overheating detection portion may be additionally be provided that includes a temperature sensor to check whether or not the temperature detected by the temperature sensor is equal to or higher than a predetermined level so that, based on the result of the checking, the chopper regulator circuit stops the supply of electric power.

With this configuration, in case the temperature in or near the circuit abnormally rises for some cause, the condition is detected and the supply of electric power is stopped. Thus, it is possible to minimize damage to and other adverse effects on the device incorporating the chopper regulator circuit.

In the above configuration, the chopper regulator circuit may be connected to an LED as the first load and to an organic EL element as the second load so as to supply the LED and the organic EL element with electric power. According to another aspect of the present invention, an electronic device is provided with a chopper regulator circuit configured as described above. This makes it possible to realize an electronic device that benefits from the configuration described above.

### BRIEF DESCRIPTION OF THE DRAWINGS

These and other objects and features of the present invention will be apparent from the following detailed description of preferred embodiments thereof taken in conjunction with the accompanying drawings, in which

FIG. 1 is a configuration diagram of a power supply circuit as one embodiment, Embodiment 1, of the present invention;

FIG. 2 is a configuration diagram of a power supply circuit as another embodiment, Embodiment 2, of the present invention;

FIG. 3 is a configuration diagram of a power supply circuit as another embodiment, Embodiment 3, of the present invention;

FIG. 4 is a configuration diagram of a power supply circuit as another embodiment, Embodiment 4, of the present invention;

FIG. 5 is a configuration diagram of a power supply circuit as another embodiment, Embodiment 5, of the present invention;

FIG. 6 is a configuration diagram of a power supply circuit as another embodiment, Embodiment 6, of the present invention;

FIG. 7 is a configuration diagram of a power supply circuit as another embodiment, Embodiment 7, of the present invention;

FIG. 8 is a configuration diagram of a power supply circuit as another embodiment, Embodiment 8, of the present invention;

FIG. 9 is a configuration diagram of a power supply circuit as another embodiment, Embodiment 9, of the present invention;

FIG. 10 is a configuration diagram of a power supply circuit as another Embodiment, Embodiment 10, of the present invention;

FIG. 11 is a configuration diagram of a power supply circuit as another Embodiment, Embodiment 11, of the present invention;

FIG. 12 is a flow chart showing the flow of operations performed to control switching in Embodiment 7 of the present invention;

FIG. 13 is a configuration diagram of an example of a conventional power supply circuit; and

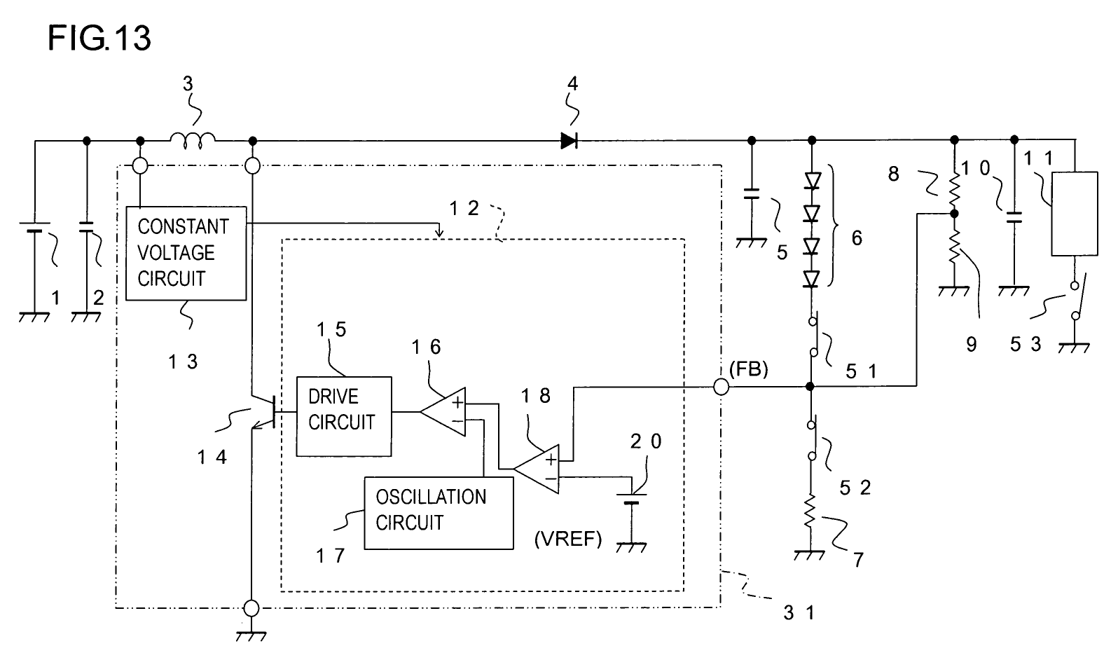

FIG. 14 is a diagram illustrating how a PWM signal is generated.

### DETAILED DESCRIPTION OF PREFERRED EMBODIMENTS

Hereinafter, how the present invention is practiced will be described by way of a number of embodiments thereof, namely Embodiments 1 to 11.

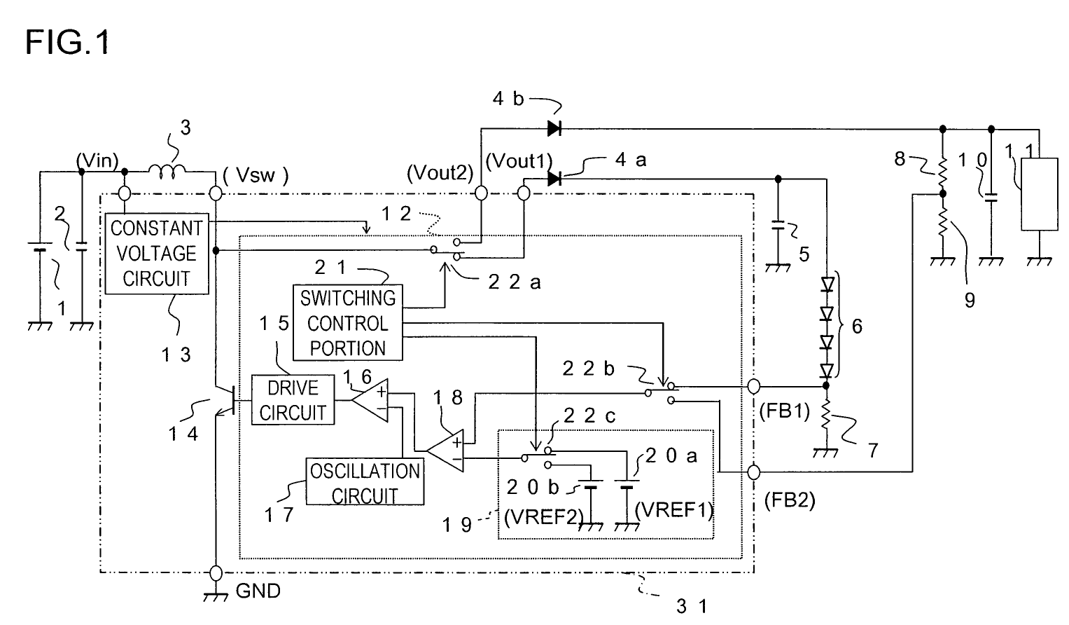

Embodiment 1: As a first embodiment of the present invention, a chopper-regulator-type power supply circuit will be described below that is connected to an LED group (which may be a single LED, or a plurality of LEDs connected in series) and an organic EL element to supply electric power selectively to one of them. The configuration of this power supply circuit is shown in FIG. 1.

As shown in FIG. 1, the power supply circuit includes a DC (direct-current) power source 1, an input capacitor 2, a coil 3, a first diode 4a, a second diode 4b, a first output capacitor 5, resistors 7 to 9, a second output capacitor 10, a chopper regulator IC 31, and other components. Configured as shown in FIG. 1, the power supply circuit supplies the LED group 6 and the organic EL element 11 with electric power.

The negative terminal of the DC power source 1 is grounded, and the positive terminal of the DC power source 1 is connected to one end of the input capacitor 2 and to one end of the coil 3. The other end of the input capacitor 2 is grounded. The cathode of the first diode 4a is connected to one end of the first output capacitor 5 and to the upstream end of the LED group 6. The other end of the first output capacitor 5 is grounded. The downstream end of the LED group 6 is grounded via the resistor 7.

The cathode of the second diode 4b is connected to the upstream end of the resistor 8, to one end of the second output capacitor 10, and to the upstream end of the organic EL element 11. The downstream end of the resistor 8 is grounded via the resistor 9. The other end of the second output capacitor 10 and the downstream end of the organic EL element 11 are grounded.

The chopper regulator IC 31 is composed of an NPN transistor acting as an output switching transistor 14, a control circuit 12, a constant voltage circuit 13 supplying the control circuit 12 with a voltage, and other components. The control circuit 12 includes a drive circuit 15, a PWM comparator 16, an oscillation circuit 17, an error amplifier 18, a reference voltage circuit 19, a switching control portion 21, a first switch 22a, a second switch 22b, and other components. The output switching transistor 14 may be replaced with an N-channel FET or the like.

The constant voltage circuit 13 receives electric power from between the DC power source 1 and the coil 3, turns the electric power into a constant voltage, and supplies the constant voltage, as driving electric power, to the control circuit 12. The collector of the output switching transistor 14 is connected to the downstream end of the coil 3, and the emitter of the output switching transistor 14 is grounded.

The second switch 22b feeds either the voltage between the LED group 6 and the resistor 7 or the voltage divided between the resistors 8 and 9 to the non-inverting input terminal of the error amplifier 18. The PWM comparator 16 compares the output of the error amplifier 18 with the output of the oscillation circuit 17, and feeds the resulting signal to the drive circuit 15.

Based on the signal fed from the PWM comparator 16, the drive circuit 15 controls the output switching transistor 14. The first switch 22a connects the downstream end of the coil 3 either to the anode of the first diode 4a or to the anode of the second diode 4b. The reference voltage circuit 19 includes a first reference voltage source 20a generating a reference voltage VREF1, a second reference voltage source 20b generating a reference voltage VREF2, and a third switch 22c feeding one of those reference voltages to the inverting input terminal of the error amplifier 18.

The switching control portion 21 feeds switching signals to the switches 22a to 22c respectively to control their switching. More specifically, when electric power is supplied to the LED group 6, the switching control portion 21 controls the first switch 22a to connect the downstream end of the coil 3 to the anode of the first diode 4a, controls the second switch 22b to connect the downstream end of the LED group 6 to the non-inverting input terminal of the error amplifier 18, and controls the third switch 22c to connect the first reference voltage source 20a to the inverting input terminal of the error amplifier 18.

In contrast, when electric power is supplied to the organic EL element 11, the switching control portion 21 controls the first switch 22a to connect the downstream end of the coil 3 to the anode of the second diode 4b, controls the second switch 22b to connect the downstream end of the resistor 8 to the non-inverting input terminal of the error amplifier 18, and controls the third switch 22c to connect the second reference voltage source 20b to the inverting input terminal of the error amplifier 18.

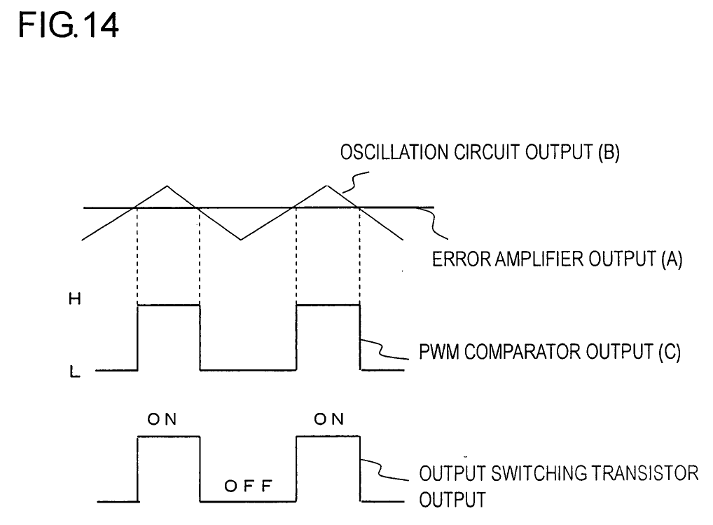

In this configuration, when the LED group 6 is driven, as electric power is supplied to the LED group 6, a voltage (feedback voltage) commensurate with the current through the LED group 6 appears across the resistor 7. The deviation of this feedback voltage from the reference voltage VREF1 outputted from the reference voltage circuit 19 is amplified by the error amplifier 18. Then, as shown in FIG. 14, the output (A) of the error amplifier 18 and the triangular oscillation wave (B) outputted from the oscillation circuit 17 are subjected to pulse width modulation by the PWM comparator 16, so that, by the resulting modulated signal, the output switching transistor 14 is controlled via the drive circuit 15.

When the output switching transistor 14 is on, a current flows through a coil 3 to the output switching transistor 14, storing energy in the coil 3. During this period, a current is supplied from the first output capacitor 5 to the LED group 6. In contrast, when the output switching transistor 14 is off, the energy stored in the coil 3 raises, via the first diode 4a, the output voltage, and the raised voltage charges the first output capacitor 5, and supplies the LED group 6 with a current.

In terms of the reference voltage VREF1 and the resistance R7 of the resistor 7, the current Io through the LED group 6 is given by

Io=VREF1/R7.

### To minimize the power loss in the resistor 7, the level of VREF1 is set low (for example, 0.1 V). This permits the LED group 6 to be driven efficiently.

On the other hand, when the organic EL element 11 is driven, as the output voltage is supplied to the organic EL element 11, the output voltage is divided by the resistors 8 and 9 so that a division voltage is fed back. The deviation of the voltage thus fed back from the reference voltage VREF2 outputted from the reference voltage circuit 19 is amplified by the error amplifier 18.

Then, as shown in FIG. 14, the output (A) of the error amplifier 18 and the triangular oscillation wave (B) outputted from the oscillation circuit 17 are subjected to pulse width modulation by the PWM comparator 16, so that, by the resulting modulated signal, the output switching transistor 14 is controlled via the drive circuit 15, and thereby the output voltage is kept constant. In consideration of the chip fabrication process and other factors, the level of VREF2 is set comparatively high (for example, 1V) to reduce variations in VREF2. This permits the output voltage to the organic EL element 11 to have a highly accurate voltage.

As described above, when the LED group 6 is driven, the chopper regulator circuit operates with reduced power loss in the resistor 7 and hence with high efficiency so as to prolong the battery life as much as possible. On the other hand, when the organic EL element 11 is driven, the chopper regulator circuit supplies it with a highly accurate output voltage.

This is achieved by the switching control portion 21 appropriately controlling the switch (first switch 22a) for switching designations (loads) to which to supply electric power, the switch (second switch 22b) for switching sources from which to receive a feedback of the output current or voltage, and the switch (third switch 22c) for switching reference voltage sources.

Thus, the components needed to supply electric power (the DC power source 1, the input capacitor 2, the coil 3, etc.) and the components needed to control the supply of electric power (the drive circuit 15, the output switching transistor 14, etc.) can be shared for the supplying of electric power to the two loads. Moreover, even in a case where different electric power supply destinations require different voltage sources (20a and 20b) as optimal, by appropriately controlling the switches, it is possible to always adopt whichever of the reference voltage sources is optimal.

The timing with which the switching control portion 21 outputs the switching signals, that is, the timing with which electric power supply destinations are switched, may be, for example, at fixed time intervals, or on receiving an instruction from outside, or in one of various other patterns.

As described above, the power supply circuit of Embodiment 1 is a chopper-regulator-type power supply circuit that is connected to an LED group 6 and an organic EL element 11 to supply them with electric power. The power supply circuit includes components (such as a DC power source 1 and a coil 3) for outputting electric power to those loads, components (such as a resistor 7) for detecting as a detected voltage the current outputted to the LED group 6, and components (such as resistors 8 and 9) for detecting as a detected voltage the voltage outputted to the organic EL element 11.

The power supply circuit further includes a first and a second reference voltage source 20a and 20b for generating reference voltages VREF1 and VREF2 respectively and components (such as a drive circuit 15, a PWM comparator 16, and an error amplifier 18) for comparing two input voltages to control, based on the result of the comparison, the amount of outputted electric power.

The power supply circuit further includes a first switch 22a for switching which of the LED group 6 and the organic EL element 11 to supply electric power to and a second and a third switch 22b and 22c for switching voltages to be fed to the error amplifier 18. It is preferable, though not essential, that the reference voltage VREF1 outputted from the first reference voltage source 20a be lower than the reference voltage VREF2 outputted from the second reference voltage source 20b.

Embodiment 2: Next, as a second embodiment of the present invention, again, a power supply circuit will be described below. The configuration here is largely the same as that in Embodiment 1, the chief difference being the additional provision of a delay circuit. Accordingly, no overlapping description will be repeated.

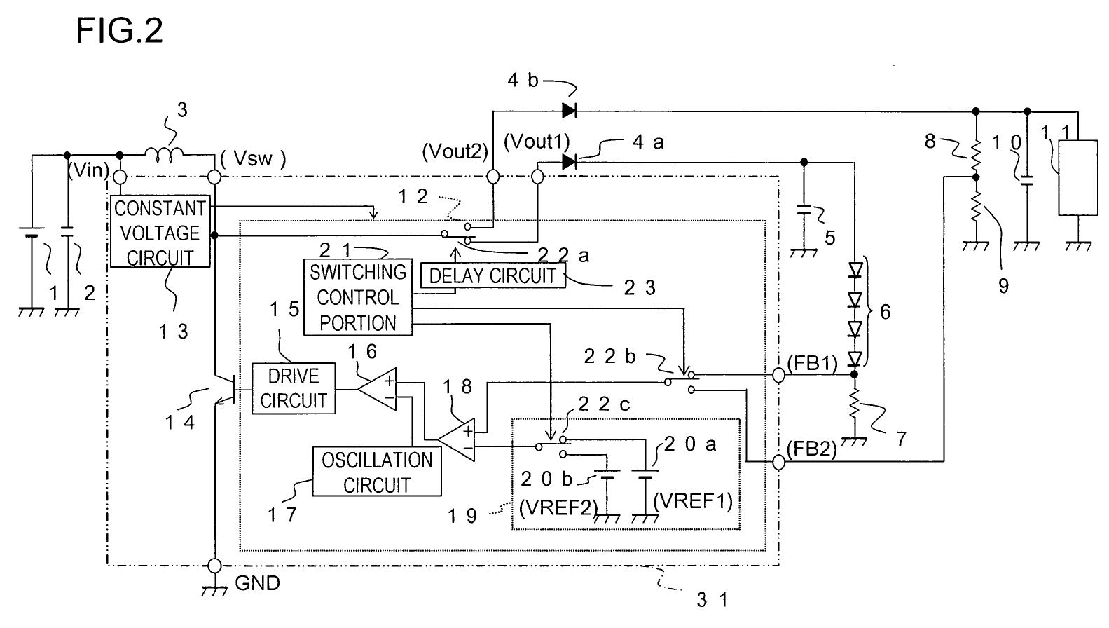

The configuration of the power supply circuit of this embodiment is shown in FIG. 2. As shown there, in the chopper regulator IC 31, a delay circuit 23 is additionally provided between the switching control portion 21 and the first switch 22a. The delay circuit 23 delays by a predetermined length of time the switching signal the switching control portion 21 outputs to control the switching of the first switch 22a, and then feeds the delayed switching signal to the first switch 22a.

Thanks to the delay circuit 23, even when the switching control portion 21 simultaneously outputs the switching signals for switching the first to third switches 22a to 22c, the switching signal for the first switch 22a can be supplied there with a delay relative to those for the other switches 22b and 22c.

This makes it possible, without complicating the control performed by the switching control portion 21, to perform the switching (input switching) between sources from which to obtain the voltage to be fed back and between reference voltage sources 20a and 20b properly prior to the switching (load switching) between destinations to which to supply electric power. Thus, even when electric power starts to be supplied before the feedback voltage sources and the reference voltage sources 20a and 20b are properly set (ready to operate), with Embodiment 2, it is possible to prevent instability in the control of the supply of electric power as much as possible.

Embodiment 3: Next, as a third embodiment of the present invention, again, a power supply circuit will be described below. The configuration here is largely the same as that in Embodiment 1, the chief difference lying in the configuration of the reference voltage circuit 19. Accordingly, no overlapping description will be repeated.

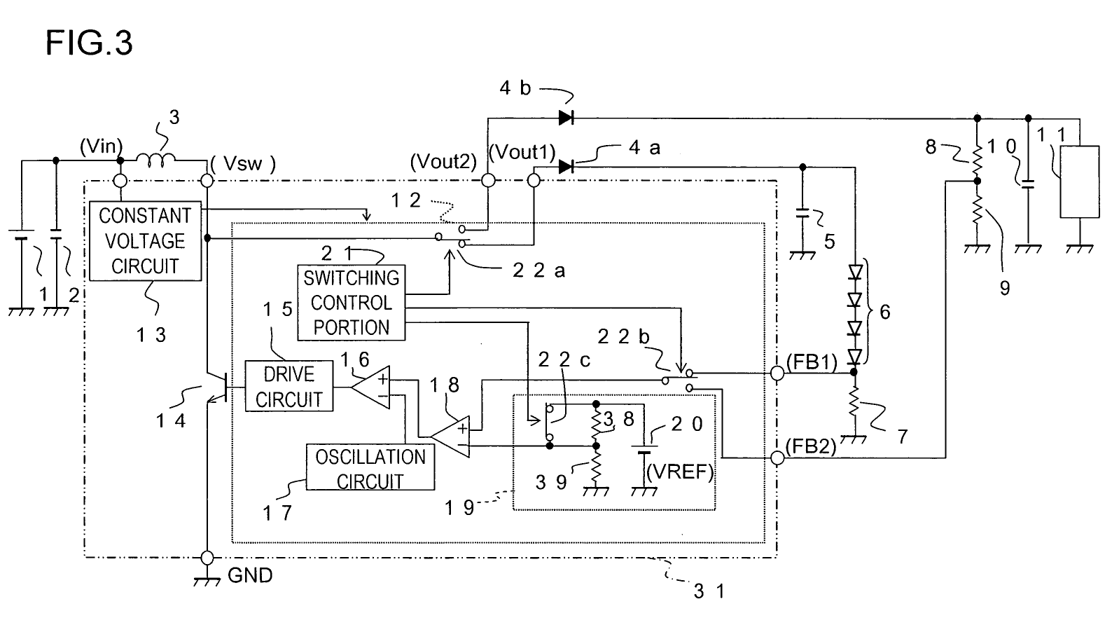

The configuration of the power supply circuit of this embodiment is shown in FIG. 3. As shown there, the reference voltage circuit 19 includes a reference voltage source 20, a resistor 38, a resistor 39, a third switch 22c, and other components.

The reference voltage source 20 generates a predetermined reference voltage VREF, and its negative end is grounded. The positive end of the reference voltage source 20 is connected to one end of the resistor 38 and to one end of the third switch 22c. The other end of the resistor 38 is grounded via the resistor 39. The node between the resistors 38 and 39 is connected to the other end of the third switch 22c and to the inverting input terminal of the error amplifier 18. The contacts of the third switch 22c are connected together and disconnected from each other according to a switching signal from the switching control portion 21.

With this configuration, in this embodiment, when the third switch 22c is open, a voltage divided from the reference voltage VREF by the resistors 38 and 39 is fed to the inverting input terminal of the error amplifier 18. In contrast, when the third switch 22c is closed, the reference voltage VREF is, almost intact, fed to the inverting input terminal of the error amplifier 18. That is, through the switching of the third switch 22c, the reference voltage fed to the inverting input terminal of the error amplifier 18 is changed (one of different reference voltages is fed to it).

Thus, by using the reference voltage VREF and a voltage divided from it respectively as VREF2 and VREF1 in Embodiment 1, it is possible to reduce the number of reference voltage sources (share a single one) in the reference voltage circuit 19 while achieving substantially the same overall operation as in Embodiment 1. Reducing the number of voltage sources needed facilitates the miniaturization and cost reduction of the device incorporating the chopper regulator.

Embodiment 4: Next, as a fourth embodiment of the present invention, again, a power supply circuit will be described below. The configuration here is largely the same as that in Embodiment 1, the chief difference being that the supply of electric power to the loads is achieved by synchronous rectification. Accordingly, no overlapping description will be repeated.

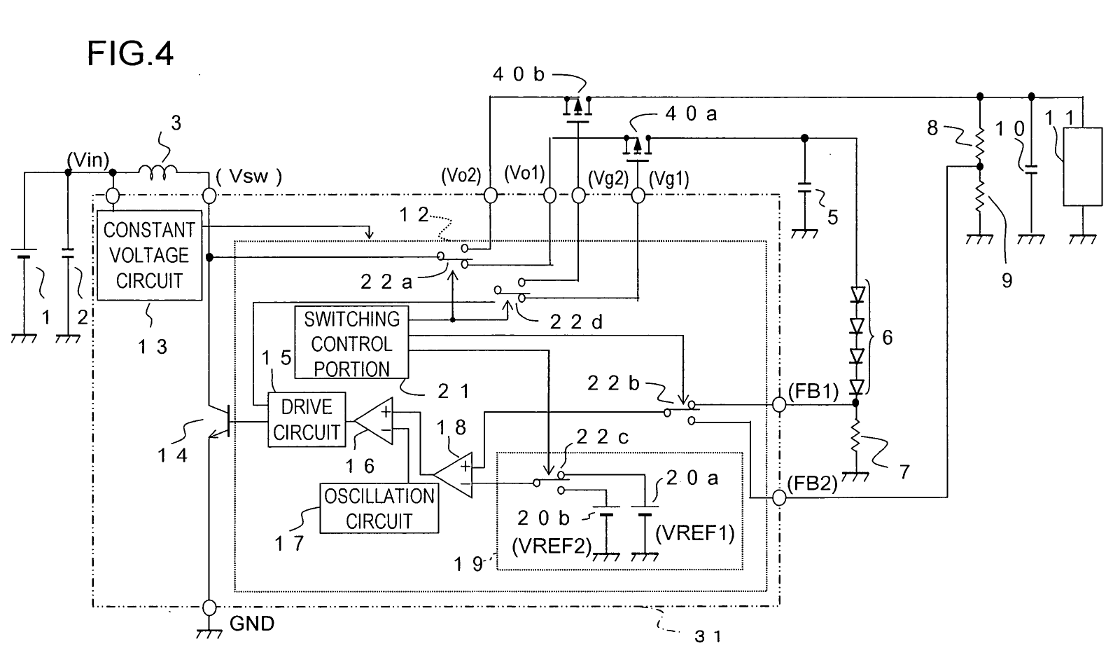

The configuration of the power supply circuit of this embodiment is shown in FIG. 4. As shown there, the power supply circuit includes a first rectifying FET 40a, a second rectifying FET 40b, and a fourth switch 22d. Provided in place of the first and second diodes 4a and 4b in Embodiment 1, the first and second rectifying FETs 40a and 40b achieve synchronous rectification.

More specifically, the source of the first rectifying FET 40a is connected to one downstream terminal of the first switch 22a, and the drain of the first rectifying FET 40a is connected to the upstream end of the LED group 6. The gate of the first rectifying FET 40a is connected to one downstream end of the fourth switch 22d. The source of the second rectifying FET 40b is connected to the other downstream end of the first switch 22a, and the drain of the second rectifying FET 40b is connected to the upstream end of the organic EL element 11. The gate of the second rectifying FET 40b is connected to the other downstream end of the fourth switch 22d.

As described above, the fourth switch 22d has its two downstream ends connected to the first rectifying FET 40a and the second rectifying FET 40b respectively, and has its upstream end connected to the drive circuit 15. Thus, according to a switching signal from the switching control portion 21, the fourth switch 22d connects the drive circuit 15 selectably either to the first rectifying FET 40a or to the second rectifying FET 40b.

Moreover, the drive circuit 15 on one hand controls the output switching transistor 14 as in Embodiment 1, and on the other hand outputs a signal via the fourth switch 22d to one of the first and second rectifying transistors 40a and 40b so as to perform synchronous rectification. Synchronous rectification itself is well-known, and therefore no detailed description of it will be given.

The switching control portion 21 controls the switching of not only the first to third switches 22a to 22c but also the fourth switch 22d. More specifically, when electric power is supplied to the LED group 6, the switching control portion 21 controls the first switch 22a to connect the downstream end of the coil 3 to the first rectifying FET 40a, controls the second switch 22b to connect the downstream end of the LED group 6 to the non-inverting input terminal of the error amplifier 18, controls the third switch 22c to connect the first reference voltage source 20a to the inverting input terminal of the error amplifier 18, and controls the fourth switch 22d to connect the drive circuit 15 to the first rectifying FET 40a.

In contrast, when electric power is supplied to the organic EL element 11, the switching control portion 21 controls the first switch 22a to connect the downstream end of the coil 3 to the second rectifying FET 40b, controls the second switch 22b to connect the downstream end of the resistor 8 to the non-inverting input terminal of the error amplifier 18, controls the third switch 22c to connect the second reference voltage source 20b to the inverting input terminal of the error amplifier 18, and controls the fourth switch 22d to connect the drive circuit 15 to the second rectifying FET 40b.

With the above configuration, the power supply circuit of this embodiment supplies the LED group 6 or the organic EL element 11 with electric power by synchronous rectification. Thus, rectification is achieved with rectifying FETs, which have a lower forward voltage (source-to-drain voltage) than fly-wheel diodes. This helps further increase the efficiency with which electric power is supplied to the loads.

Embodiment 5: Next, as a fifth embodiment of the present invention, again, a power supply circuit will be described below. The configuration here is largely the same as that in Embodiment 1, the chief difference being that the switching control portion 21 is controlled by a signal fed from outside. Accordingly, no overlapping description will be repeated.

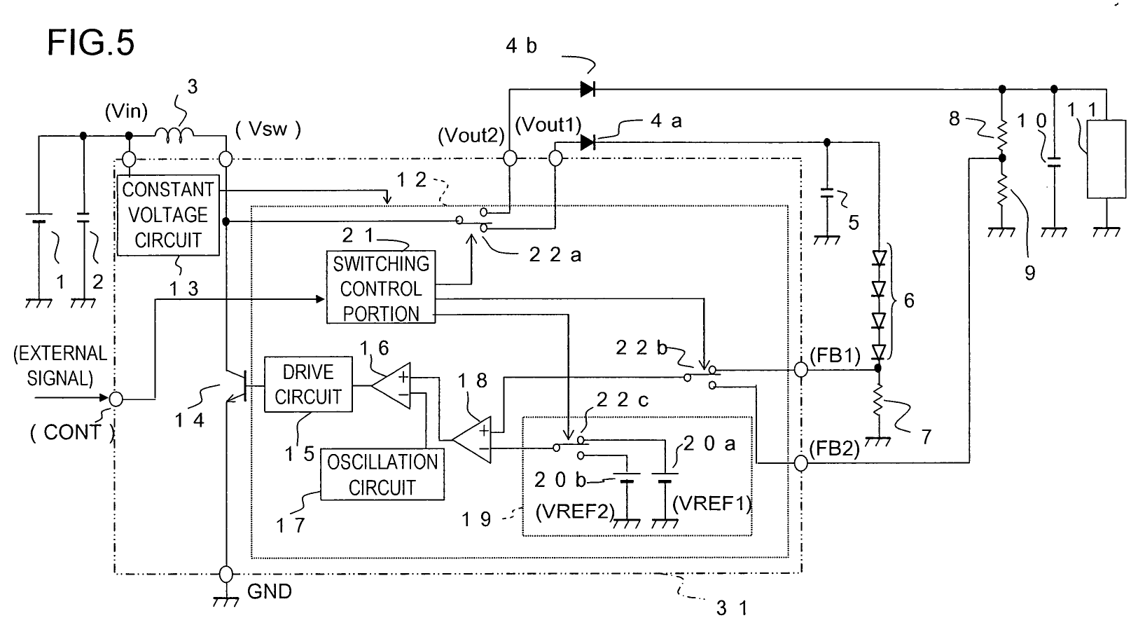

The configuration of the power supply circuit of this embodiment is shown in FIG. 5. As shown there, the chopper regulator IC 31 provided in the power supply circuit is provided with a CONT terminal to which a signal (external signal) is fed from outside. The CONT terminal is connected to the switching control portion 21 so that, by the external signal, the operation of the switching control portion 21 is controlled.

Specifically, for example, the switching control portion 21 is so controlled as to control the switches 22a to 22c (make these perform load switching and input switching) such that, when the external signal is logically high (at level “H”), electric power is supplied to the LED group 6 and, when the external signal is logically low (at level “L”), power is supplied to the organic EL element 11.

With this configuration, the operation of the switching control portion 21 can be controlled from outside the power supply circuit. This makes it easy to instruct the power supply circuit, from outside it, which of the LED group 6 and the DC power source 1 to supply electric power to.

Embodiment 6: Next, as a sixth embodiment of the present invention, again, a power supply circuit will be described below. The configuration here is largely the same as that in Embodiment 1, the chief difference being the provision of an output voltage detection circuit and the configuration around it. Accordingly, no overlapping description will be repeated.

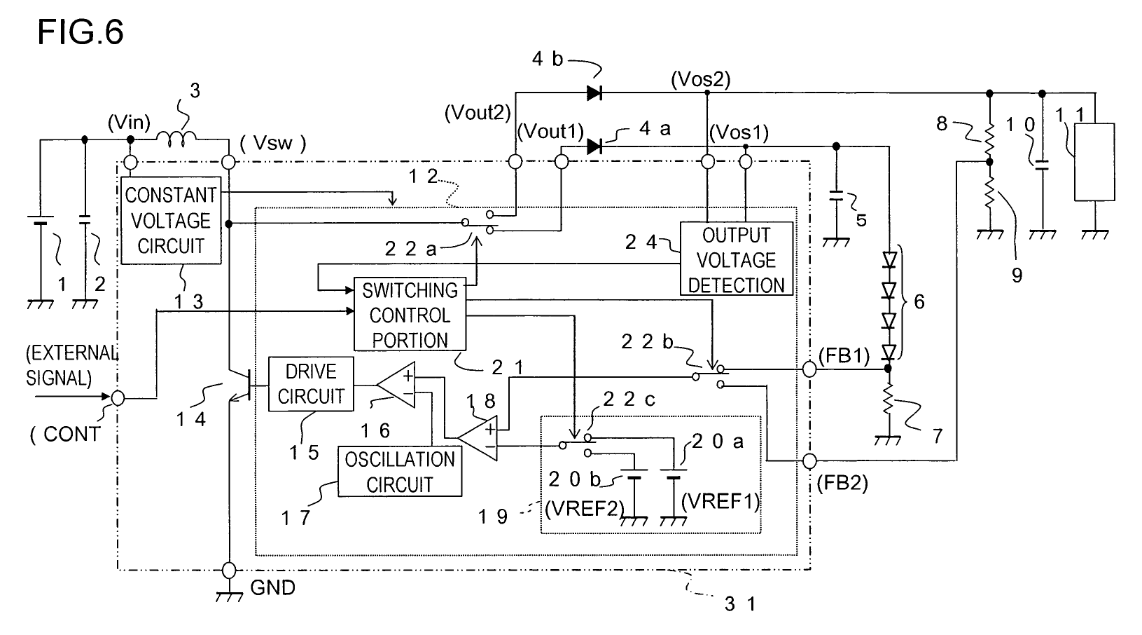

The configuration of the power supply circuit of this embodiment is shown in FIG. 6. Here, the chopper regulator IC 31 provided in the power supply circuit includes an output voltage detection circuit 24. On its input side, the output voltage detection circuit 24 is connected to the cathodes of the first and second diodes 4a and 4b; on its output side, the output voltage detection circuit 24 is connected to the switching control portion 21. Thus, the output voltage detection circuit 24 detects the output voltages fed to the LED group 6 and the organic EL element 11, and feeds the results to the switching control portion 21.

Accordingly, the switching control portion 21, when switching power supply destinations (the LED group 6 and the organic EL element 11), does it based on the results of the detection by the output voltage detection circuit 24 as well. More specifically, at a transition from a state in which electric power is supplied to one load to a state in which electric power is supplied to the other load, load switching is performed in such a way that, after the output voltage to the first load (the one to which electric power has thus far been supplied) has fallen sufficiently low (to equal to or lower than a predetermined level), electric power starts to be supplied to the second load.

With this configuration, when loads to which to supply electric power are switched, it is possible to easily prevent electric power from being supplied to the two loads simultaneously.

Embodiment 7: Next, as a seventh embodiment of the present invention, again, a power supply circuit will be described below. The configuration here is largely the same as that in Embodiment 6, the chief difference being the provision of discharge switches and the configuration around it. Accordingly, no overlapping description will be repeated.

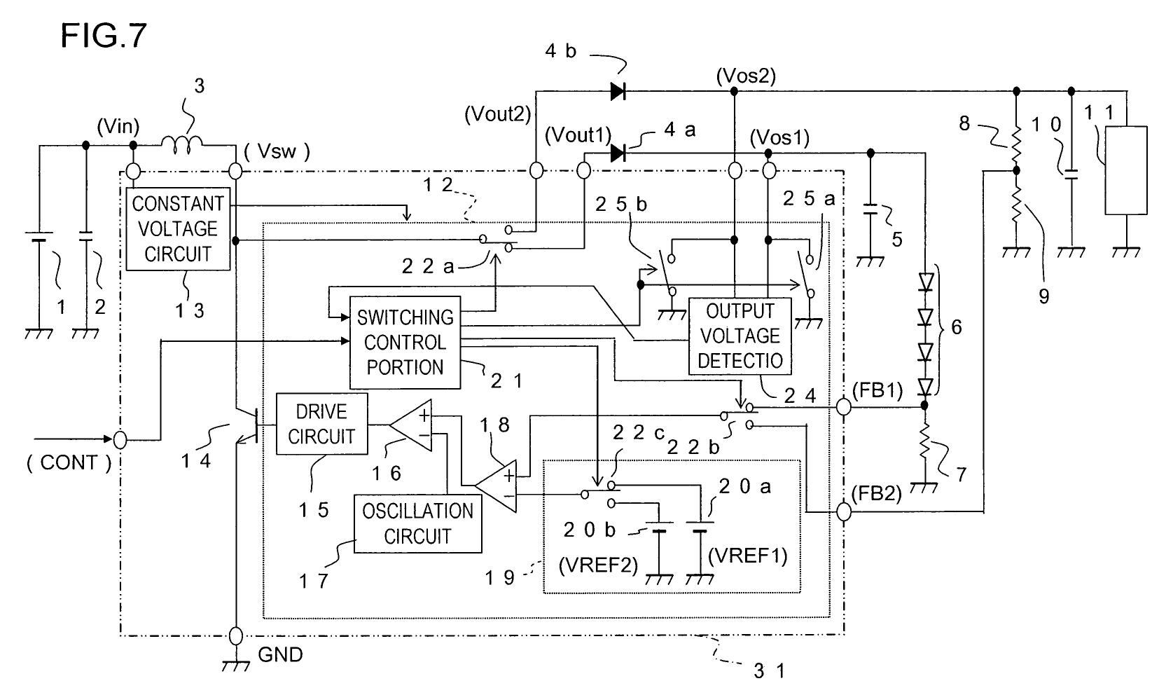

The configuration of the power supply circuit of this embodiment is shown in FIG. 7. Here, the chopper regulator IC 31 provided in the power supply circuit includes a first discharge switch 25a and a second discharge switch 25b. The first discharge switch 25a is so connected that it can connect and disconnect the cathode of the first diode 4a to and from a grounded node. Likewise, the second discharge switch 25b is so connected that it can connect and disconnect the cathode of the second diode 4b to and from a grounded node.

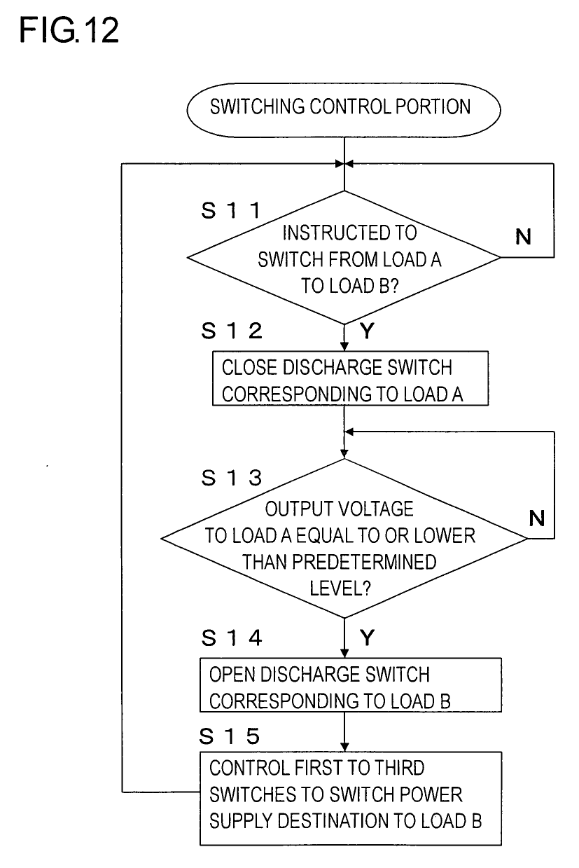

With this configuration, by closing the first discharge switch 25a, it is possible to make the output voltage to the LED group 6 fall quickly. Likewise, by closing the second discharge switch 25b, it is possible to make the output voltage to organic EL element 11 fall quickly. The switching of these discharge switches 25a and 25b is controlled by a switching signal outputted from the switching control portion 21. Now, the flow of operations performed to control the switching of the discharge switches will be described with reference to the flow chart in FIG. 12.

The switching control portion 21 monitors the presence of an external signal (instruction signal) that is fed to the CONT terminal from outside to instruct the power supply circuit to switch electric power supply destinations (step S11). Let the destination to which electric power is supplied until load switching takes place be “load A”, and the destination to which electric power will be supplied after load switching be “load B”. When the switching control portion 21 detects the instruction signal (Y (yes) in step S11), it outputs a control signal to thereby close the discharge switch corresponding to load A (step S12).

Thereafter, the switching control portion 21 monitors, via the output voltage detection circuit 24, the output voltage to the load A to check whether or not it has fallen to or below a predetermined level (step S13). When the output voltage has fallen to or below the predetermined level (Y in step S13), the switching control portion 21 opens the discharge switch corresponding to load B (step S14) and controls the first to third switches 22a to 22c so that the electric power supply designation is switched to load B (step S15).

Through the flow of operations described above, when electric power supply destinations are switched, the output voltage to the destination that has been supplied with electric power before load switching can be made to fall quickly. Also, the load switching can be performed after the output voltage to that destination has fallen sufficiently (to equal to or lower than a predetermined level).

Embodiment 8: Next, as an eighth embodiment of the present invention, again, a power supply circuit will be described below. The configuration here is largely the same as that in Embodiment 5, the chief difference lying in how external signals are acquired and how the switching control portion 21 operates. Accordingly, no overlapping description will be repeated.

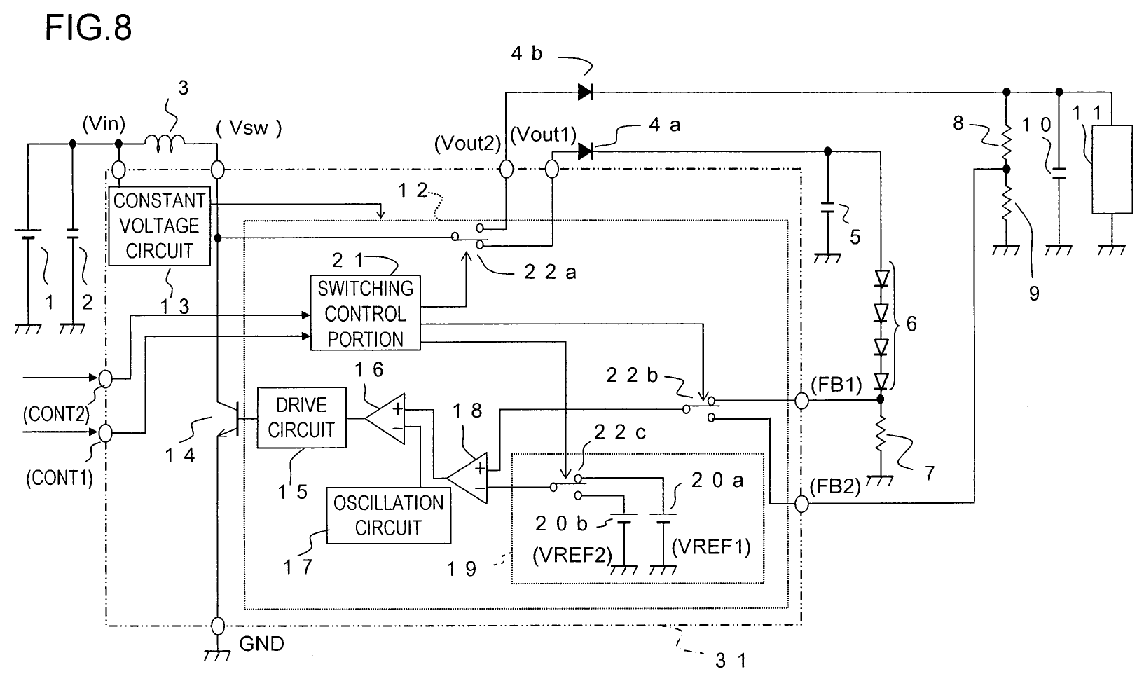

The configuration of the power supply circuit of this embodiment is shown in FIG. 8. Here, the chopper regulator IC 31 provided in the power supply circuit is provided with two terminals CONT1 and CONT2, at which it acquires external signals. These terminals are both connected to the switching control portion 21.

When a logically high (level “H”) signal is fed to the terminal CONT1 and a logically high signal is fed to the terminal CONT2, the switching control portion 21 controls the switches 22a to 22c so that electric power is supplied to the LED group 6. When a logically low (level “L”) signal is fed to the terminal CONT1 and a logically high signal is fed to the terminal CONT2, the switching control portion 21 controls the switches 22a to 22c so that electric power is supplied to the organic EL element 11. When a logically low signal is fed to the terminal CONT2, neither of the loads is supplied with electric power.

Thus, the signal fed to the terminal CONT1 is used to switch electric power supply destinations, and the signal fed to the terminal CONT2 is used to turn the supply of electric power on and off. Providing separate terminals in this way—one for feeding an external signal related to the switching of electric power supply destinations to the switching control portion 21 and another for feeding an external signal related to the turning on and off of the supply of electric power to the switching control portion 21—makes it easier to feed signals to the switching control portion 21 from outside.

To permit the supply of electric power to be stopped such that neither of the loads receives it, for example, the first switch 22a is so built as to have a state in which its input contact is connected to neither of its output contact, and is so controlled by the switching control portion 21 as to be brought into that state whenever necessary.

Embodiment 9: Next, as a ninth embodiment of the present invention, again, a power supply circuit will be described below. The configuration here is largely the same as that in Embodiment 8, the chief difference being the provision of an ON/OFF circuit. Accordingly, no overlapping description will be repeated.

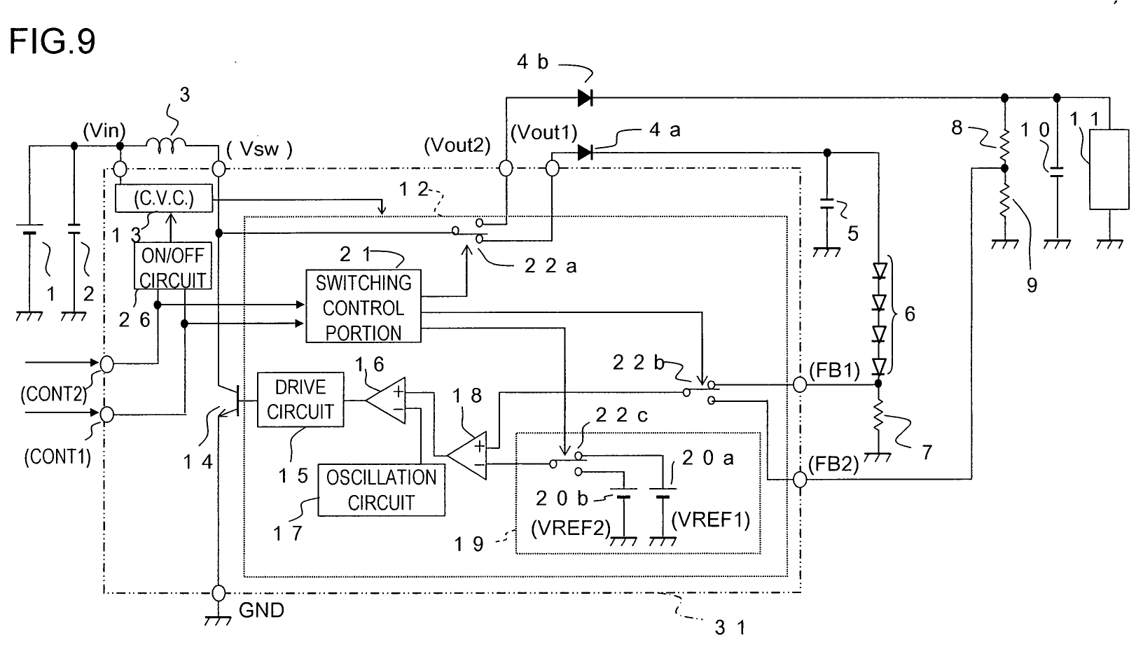

The configuration of the power supply circuit of this embodiment is shown in FIG. 9. As shown there, the chopper regulator IC 31 provided in the power supply circuit includes an ON/OFF circuit 26. On its input side, the ON/OFF circuit 26 is connected to the terminals CONT1 and CONT2 for receiving external signals to be fed to the switching control portion 21. Thus, the external signals fed to the terminals CONT1 and CONT2 are fed not only to the switching control portion 21 but also to the ON/OFF circuit 26.

When a logically low (level “L”) signal is fed to the terminal CONT2 (or to both the terminals CONT1 and CONT2) (that is, when the supply of electric power is stopped such that neither of the LED group 6 and the organic EL element 11 receives it), the ON/OFF circuit 26 stops the supply of the driving voltage to the control circuit 12 by the constant voltage circuit 13. Thus, when no electric power is supplied to either of the loads, the supply of the driving voltage to the control circuit 12 can also be stopped. This helps further reduce unnecessary electric power consumption.

Embodiment 10: Next, as a tenth embodiment of the present invention, again, a power supply circuit will be described below. The configuration here is largely the same as that in Embodiment 5, the chief difference being the provision of an abnormal voltage detection circuit. Accordingly, no overlapping description will be repeated.

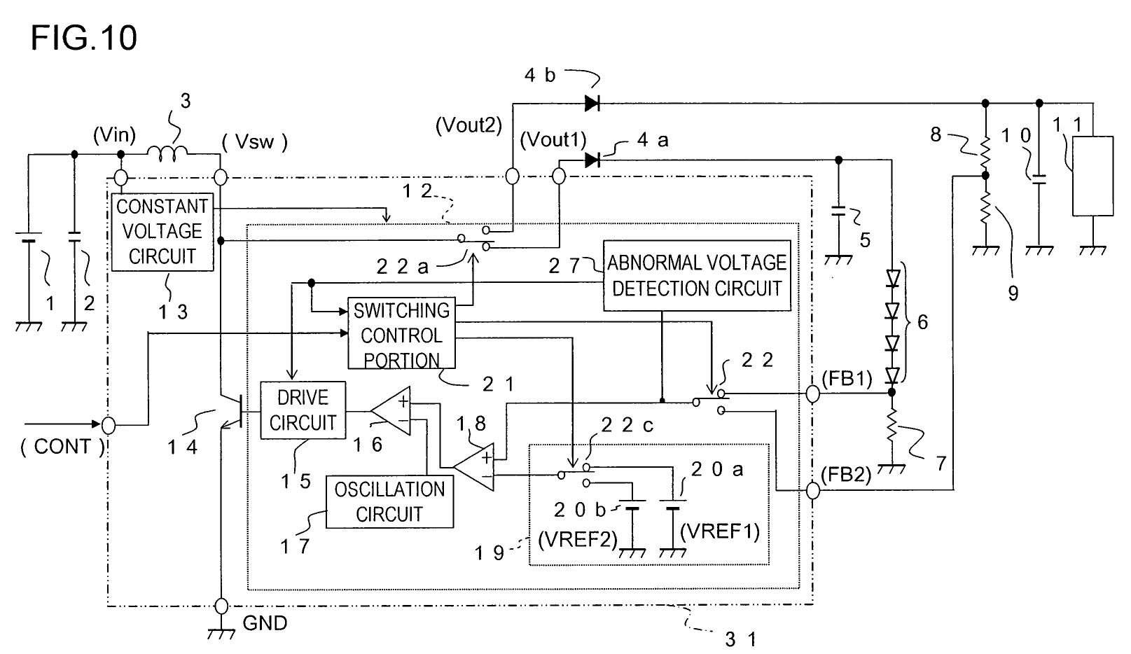

The configuration of the power supply circuit of this embodiment is shown in FIG. 10. As shown there, the chopper regulator IC 31 provided in the power supply circuit includes an abnormal voltage detection circuit 27. On its input side, the abnormal voltage detection circuit 27 is connected to the non-inverting input terminal of the error amplifier 18. Thus, the abnormal voltage detection circuit 27 detects a voltage (feedback voltage) fed back from the LED group 6 or the organic EL element 11.

The abnormal voltage detection circuit 27 checks whether or not the detected feedback voltage is higher than a predetermined reference level; if so, it assumes a failure such as short-circuiting and stops the supply of electric power to the loads. More specifically, it then outputs a signal to the drive circuit 15 to make it stop the operation of the output switching transistor 14.

The abnormal voltage detection circuit 27 also outputs a signal to the switching control portion 21 to make it control the first switch 22a properly so as to remedy the abnormal state. More specifically, the first switch 22a is so built as to have a state in which its input contact is connected to neither of its output contacts, and is so controlled by the switching control portion 21 as to be brought into that state whenever necessary.

With this configuration, even in the event of a failure such as short circuiting in a load, it is possible to prevent overvoltage-induced damage to and other adverse effects on the device incorporating the chopper regulator circuit.

Embodiment 11: Next, as an eleventh embodiment of the present invention, again, a power supply circuit will be described below. The configuration here is largely the same as that in Embodiment 5, the chief difference being the provision of an overheating protection circuit. Accordingly, no overlapping description will be repeated.

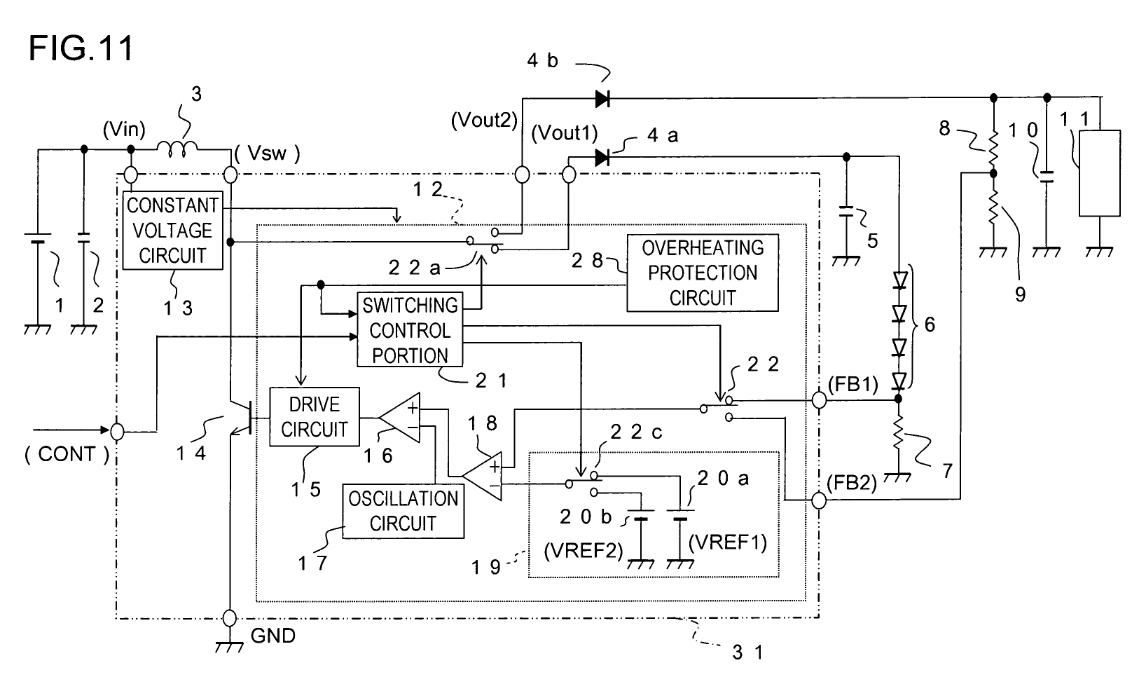

The configuration of the power supply circuit of this embodiment is shown in FIG. 11. As shown there, the chopper regulator IC 31 provided in the power supply circuit includes an overheating protection circuit 28. The overheating protection circuit 28 includes a temperature sensor, and can detect the temperature of or in the close vicinity of the chopper regulator IC 31.

The overheating protection circuit 28 checks whether or not the detected temperature is equal to or higher than a predetermined level; if so, it assumes a failure such as short-circuiting and stops the supply of electric power to the loads. More specifically, it then outputs a signal to the drive circuit 15 to make it stop the operation of the output switching transistor 14.

The overheating protection circuit 28 also outputs a signal to the switching control portion 21 to make it control the first switch 22a properly so as to remedy the abnormal state. More specifically, the first switch 22a is so built as to have a state in which its input contact is connected to neither of its output contacts, and is so controlled by the switching control portion 21 as to be brought into that state whenever necessary.

With this configuration, even in the event of a failure such as short circuiting in a load, it is possible to prevent overheating-induced damage to and other adverse effects on the device incorporating the chopper regulator circuit.

Summary: The embodiments by way of which the present invention has been described hereinbefore are in no way meant to limit how it is practiced, and many modifications and variations are possible within the spirit of the invention. Different features of different embodiments may be combined in any way unless inconsistent.

In any of the chopper regulator circuits embodying the present invention described above, the reference voltage generation portion used when electric power is supplied to the LED group 6 (a first load) is provided separate from the reference voltage generation portion used when electric power is supplied to the organic EL element 11 (a second load), and whichever of them is proper (whichever corresponds to the load to which to supply electric power) is chosen by the switching control portion 21. Thus, it is possible to easily supply either load with adequate electric power. Even a reference voltage circuit, like the reference voltage circuit 19 in Embodiment 3, that generates different reference voltages from a single shared voltage source with the help of a switch can be regarded as having separate reference voltage generation portions.

The switching of loads to which to supply electric power is achieved by the switching control portion 21 switching between the reference voltage generation portions. Thus, in the chopper regulator circuit, it is possible to share components such as a drive circuit and a power source for the supplying of electric power to either load, and thereby to minimize disadvantages such as an increase in the total number of components needed.

1. A chopper regulator circuit connected to first and second loads to supply electric power thereto, the chopper regulator circuit comprising:
a power output portion outputting electric power to the first and second loads;
a first output detection portion detecting as a detected voltage a voltage or current outputted to the first load;
a second output detection portion detecting as a detected voltage a voltage or current outputted to the second load;
first and second reference voltage generation portions each generating a predetermined reference voltage;
an output control portion comparing two input voltages and controlling, based on a result of the comparison, amount of electric power outputted from the power output portion; and
a switching control portion controlling
load switching for switching which of the first and second loads to supply electric power to and
input switching for switching what voltages to handle as the input voltages,
wherein the switch control portion,
when performing the load switching so as to supply electric power to the first load, performs the input switching such that the detected voltage detected by the first output detection portion and the reference voltage generated by the first reference voltage generation portion are handled as the input voltages and,
when performing the load switching so as to supply electric power to the second load, performs the input switching such that the detected voltage detected by the second output detection portion and the reference voltage generated by the second reference voltage generation portion are handled as the input voltages.

2. A chopper regulator circuit according to claim 1,
wherein the first output detection portion detects as the detected voltage the current outputted to the first load.

3. A chopper regulator circuit according to claim 2,
wherein the second output detection portion detects as the detected voltage the voltage outputted to the second load.

4. A chopper regulator circuit according to claim 1, wherein
the first output detection portion detects as the detected voltage the current outputted to the first load, and
the second output detection portion detects as the detected voltage the voltage outputted to the second load, and
the reference voltage generated by the first reference voltage generation portion is set lower than the reference voltage generated by the second reference voltage generation portion.

5. A chopper regulator circuit according to claim 1,
wherein the switching control, prior to performing the load switching, performs the input switching.

6. A chopper regulator circuit according to claim 1,
wherein the first and second reference voltage generating portions share a predetermined voltage source, and at least one of the first and second reference voltage generating portions generates the reference voltage by dividing a voltage generated by the voltage source.

7. A chopper regulator circuit according to claim 1,
wherein the chopper regulator circuit adopts synchronous rectification.

8. A chopper regulator circuit according to claim 1,
wherein the switching control portion controls the load switching and the input switching based on a signal fed from outside.

9. A chopper regulator circuit according to claim 1,
wherein the switching control portion performs the load switching after first confirming that an output voltage to whichever of the first and second loads to which the output voltage has thus far been fed is equal to or lower than a predetermined level.

10. A chopper regulator circuit according to claim 1, further comprising:
a grounding switch by which an output path by way of which electric power is outputted to the first or second load is switched between a state connected to a grounded node and a state disconnected from the grounded node.

11. A chopper regulator circuit according to claim 8, further comprising:
supply stopping means for stopping, based on the signal fed from outside, supply of electric power such that neither of the first and second loads receives it.

12. A chopper regulator circuit according to claim 11,
wherein the supply stopping means, when stopping the supply of electric power such that neither of the first and second loads receives it, stops supply of driving electric power to the output control portion.

13. A chopper regulator circuit according to claim 1, further comprising:
an abnormal output detection portion checking whether or not the voltage or current outputted to the first or second load is equal to or higher than a predetermined level,
wherein, based on a result of the checking, the chopper regulator circuit stops supply of electric power.

14. A chopper regulator circuit according to claim 1, further comprising:
an overheating detection portion including a temperature sensor and checking whether or not a temperature detected by the temperature sensor is equal to or higher than a predetermined level,
wherein, based on a result of the checking, the chopper regulator circuit stops supply of electric power.

15. A chopper regulator circuit according to claim 1,
wherein the chopper regulator circuit is connected to an LED as the first load and to an organic EL element as the second load, and supplies electric power to the LED and the organic EL element.

16. An electronic device comprising a chopper regulator circuit according to claim 1.

17. An electronic device comprising a chopper regulator circuit according to claim 2.

18. An electronic device comprising a chopper regulator circuit according to claim 3.

19. An electronic device comprising a chopper regulator circuit according to claim 4.

20. An electronic device comprising a chopper regulator circuit according to claim 5.
